(19) United States
(12) Patent Application Publication
(10) Pub. No.: US 2003/0010400 A1
(43) Pub. Date: Jan. 16, 2003

(54) Bottle drainage coupler

(76) Inventor: Carole Varga, New York, NY (US)

Correspondence Address: M. Arthur Auslander, Esq., Auslander & Thomas, 505 Eighth Avenue, New York, NY, 10018-6505, US

(21) Appl. No.: 10/193,606

(22) Filed: Jul. 11, 2002

Related U.S. Application Data
(60) Provisional application No. 60/305,432, filed on Jul. 16, 2001.

(51) Int. Cl. B65B 3/00; B65B 3/04; B67C 3/00; B65B 1/04

(52) U.S. Cl. 141/383; 141/319

(57) ABSTRACT

A bottle drainage coupler unit has upper and lower coupler pairs to supports bottles with viscous fluid such as ketchup for stable, effective, mouth to mouth drainage. The drainage is effected without the need for supervision.

The present invention is a continuation-in-part of Provisional Application No. 60/305,432, filed Jul. 16, 2001 and relates to a stable bottle drainage coupler particularly for the bottle to bottle consolidation of viscous fluids such as ketchup.

Particularly in restaurants, it is uneconomic to discard ketchup bottles with an unused residue and impracticable to leave almost empty bottles at the table because it is slow and it is inconvenient to use the residue in the bottle.

### BACKGROUND OF THE INVENTION

The solution to the problem of what to do about the residual ketchup particularly in restaurants has led to the adoption of various coupling devices or support stands for mouth to mouth related consolidation of residual ketchup. There are many systems and devices for consolidating viscous fluids.

A further concern in the consolidation of viscous fluids particularly ketchup is to be able to consolidate as quickly as possible, inexpensively, with stability and without the need to oversee the process.

### DESCRIPTION OF THE PRIOR ART

U.S. Pat. No. 6,085,806 discloses an oil drain kit for collecting used motor oil comprising an oil drain collection pan, having a bottom wall raised at the center and sloping to its marginal extremity where it is joined with a side wall having a radial flange at the top of the wall and which extends circumferentially thereabout with a downwardly extending edge portion. The bottom wall is provided at its extremity adjacent its junction with the side wall with at least three discharge openings, each with a funnel spout extending downwardly therefrom. The spouts are adapted to receive the necks of empty oil containers which connect therewith and serve as supporting legs for the drain collection pan.

U.S. Pat. No. 5,964,260 discloses a connector device designed to connect two tubes or containers so as to allow the transfer of fluids from one tube or container to the other. The connector device includes a tubular member made from an elastic material, with the tubular member having an inner wall that includes longitudinal slits. The tubular member can be made from one individual tube or a pair of joined flanged tubes. The flanged tubular members are joined at the flange positions and held together by a collar member.

U.S. Pat. No. 5,884,678 discloses a connector device designed to connect two tubes or containers so as to allow the transfer of fluids from one tube or container to the other. The connector device includes a tubular member made from an elastic material, with the tubular member having an inner wall that includes longitudinal slits. The tubular member can be made from one individual tube or a pair of joined flanged tubes. The flanged tubular members are joined at the flange positions and held together by a collar member. Furthermore, a plurality of individual tubular members can be placed in a rectangular frame member so that the tubular members are perpendicular and integral to the frame member.

U.S. Pat. No. 5,740,654 discloses a packaging assembly intended for the extemporaneous preparation of suspensions or solutions of a solid active product in a liquid product, the active product having been freeze dried and being contained in a flask A and the liquid product being contained in a flask B closed by a dropper, a connection member enabling to put in communication the two flasks for the purpose, in a first step, to cause the liquid product to pass from flask B into flask A containing the solid product, then in a second step, to reverse the assembly and aspirate into flask B, the suspension or solution thus formed.

U.S. Pat. No. 5,642,763 discloses a liquid draining device including a body having a central passageway extending therethrough, an interior funnel formed at the top end of the central passageway near the top end of the body and an interior drip guide formed at the bottom end of the central passageway near the bottom end of the body. The funnel is for receiving any remaining liquid from a first narrow neck container disposed in an inverted relation thereover. The drip guide is for discharging any liquid draining down from the funnel through the central passageway into a second narrow neck container disposed in an upright relation thereunder.

U.S. Pat. No. 5,490,545 discloses a vortex connector system with a connector body with a projection therein to selectively abut one of a plurality of removable inserts. The removable inserts have holes with different sizes, shapes, patterns, depths and numbers, in order to allow observation of how such variations affect the vortex effect and/or flow rate of fluid between plastic bottles connected by the connector body.

U.S. Pat. No. 5,285,824 discloses an oil drainage catch pan having an open top for receiving used engine oil drained therein, has a reservoir on one end of the pan with a discharge spout and a container connected by a coupling to the spout. After collecting the used oil in the catch pan, the catch pan is tilted, causing the used oil to flow to the reservoir and drain through the spout into the container for containment and transport to a suitable location.

U.S. Pat. No. 4,625,780 discloses a vortex connector for threaded plastic bottles, provided in which the connector has a pair of opposed recesses, each connecting with an inner female helically threaded recess, the recesses connecting to one another through an axially elongated constriction venturi. One of the bottles is partially filled with water. The so-coupled bottles are pivoted so that the water containing bottle is on top, the upper bottle is given a circular swirl or two and the water flows in a clearly discernible whirlpool or vortex from the upper bottle to the lower while the displaced air flows from the lower bottle to the upper through the thus formed vortex in an educational or entertaining display.

U.S. Pat. No. 4,217,941 discloses a ketchup rapping apparatus having a pair of L-form racks hinged to one another, each adapted to hold a ketchup bottle in a stationary seated position, one of the racks being pivotable through 180 degrees from a back-to-back relationship with the other rack to carry its bottle to inverted vertical alignment with the other bottle, a resilient guide cup to be disposed between the mouth ends of the aligned bottles for avoiding glass to glass bottle contact and for guiding the bottle being inverted down into the aligned position with the other bottle, a latch for securing the pivoted rack in the inverted condition, and shock absorbing pads on the bottom of the non-inverted rack enabling rapping of the latter in the inverted condition of the apparatus against a solid surface so as to jar free a clogged ketchup flow condition without damaging the apparatus or the bottles.

U.S. Pat. No. 4,105,142 discloses a device for dispensing fluid substances which includes a dispensing container for holding a metered amount of the fluid substance therein immediately prior to dispensing and which includes a primary opening in the top edge thereof which is adapted to be capped during filling of the dispensing container and which is adapted to be opened when it is desired that the metered amount of fluid substance should be dispensed from the container, the dispensing container also includes a secondary opening in the lower section thereof which may be substantially smaller than the primary opening, the device further includes a hollow adapter secured to the secondary opening of the dispensing chamber and adapted to be secured to the neck of a bottle or other source of the fluid substance to be dispensed, the hollow adapter including a dispensing collar adapted to be secured to the secondary opening of the dispensing container and a holder collar adapted to be secured to the neck of a bottle or holder of the fluid substance.

U.S. Pat. No. 3,963,063 discloses a viscous liquid transfer device for emptying partially filled bottles of ketchup, mustard, etc. in restaurants, to make a full bottle. The device comprises an upwardly and downwardly flared cylinder having attached to an inner wall surface, a vent tube which extends into the bottle to be emptied while inverted with its neck supported on the upwardly flared portion, while the downwardly flared portion rests on the neck of the bottle to be filled.

U.S. Pat. No. 3,620,267 discloses a device for transferring viscous fluids, such as catsup, from one bottle to another, wherein an expansion chamber is provided between the pouring spouts of the bottles to enhance the downward flow of catsup by relieving the central portions thereof to permit air displaced from the lower bottle to bubble up through the flowing catsup into the upper bottle.

U.S. Pat. No. 3,266,533 discloses a draining assembly including a support base and a coupling member. The drainage assembly has a centrally recessed portion for receiving the bottom portion of a container in seated frictional engagement and a coupling member designed for slip-fit frictional engagement with the threaded outlet portion of the container. A threaded outlet portion of another container is supported in inverted position thereon.

U.S. Pat. No. 3,261,381 discloses a coupling member for tubes.

U.S. Pat. No. 3,261,380 discloses a support stand for supporting and draining ketchup bottles mouth to mouth.

U.S. Pat. No. 3,156,272 discloses an invention which relates generally to bottle coupling devices, and more particularly, to coupling devices for draining ketchup bottles or the like.

U.S. Pat. No. 2,773,521 discloses an invention which relates to an improved coupling for squeeze bottles and has for one of its principal objects the provision of a simple, efficient and easily operated device for refilling a squeeze-type dispenser container of liquids by the customer for reuse. U.S. Design Pat. No. 431,971 discloses an ornamental design for a water bottle magnetic coupler.

It is respectfully requested that this citation of art consist of record about the within application.

### BRIEF SUMMARY OF THE INVENTION

The problem of utilizing the residual viscus fluid in a container has challenged many to save the usable portions of such residual fluids. Saving the residue in ketchup bottles has been enabled particularly because of the established, shape of the many bottles and the desireabilty of being able to use the residue.

At least as early as 1962, devices have shown up in the patent art, directed specifically to the mouth to mouth type coupling of ketchup bottles to consolidate the residue of a partly used ketchup bottle into another partly used one as shown in U.S. Pat. No. 3,156,272.

The present invention is a stable bottle drainage system, particularly for the consolidation of viscous food residue with greater expedience, simplicity, stability and economy.

Although such novel feature or features believed to be characteristic of the invention are pointed out in the claims, the invention and the manner in which it may be carried out may be further understood by reference to the description following and the accompanying drawings.

### BRIEF DESCRIPTION OF THE DRAWINGS

FIG. 1 is a front elevation of the drainage coupler of the present invention.

FIG. 2 is a plan view of FIG. 1.

FIG. 3 is a vertical section of FIG. 1 showing a detail of the coupled arrangement of two bottles.

FIG. 4 is a front elevation of drainage coupler of the present invention in use with two sets of bottles.

Referring now to the figures in greater detail, where like reference numbers denote like parts in the various figures.

### DETAILED DESCRIPTION OF THE DRAWINGS

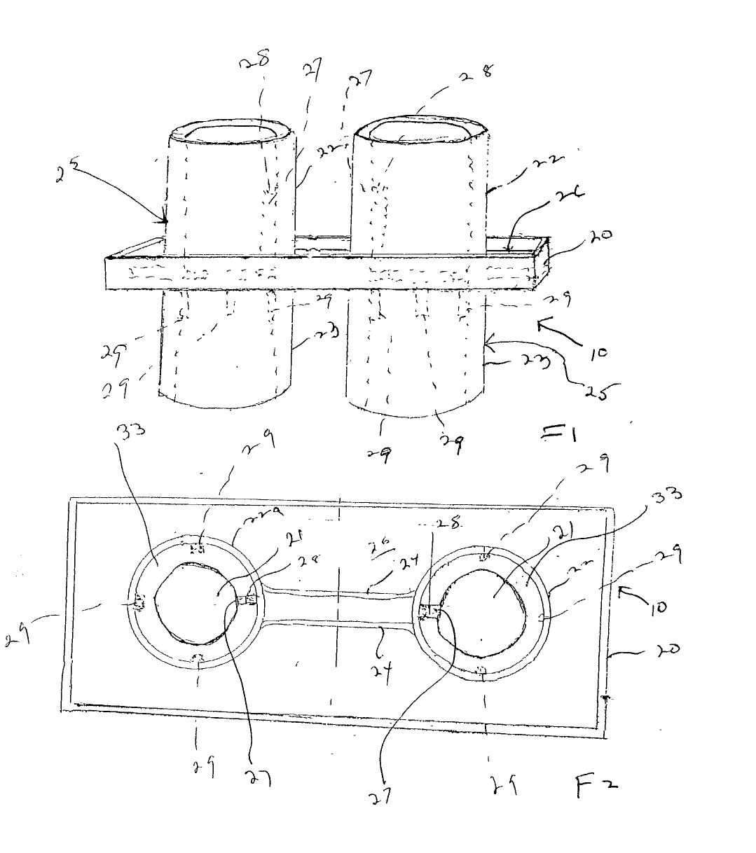

As shown in FIGS. 1-4 a 10 drainage coupler 10 includes an integral support rim 20, a base 26, a pair of bottle neck receivers 22 and a pair of bottle neck receivers 23.

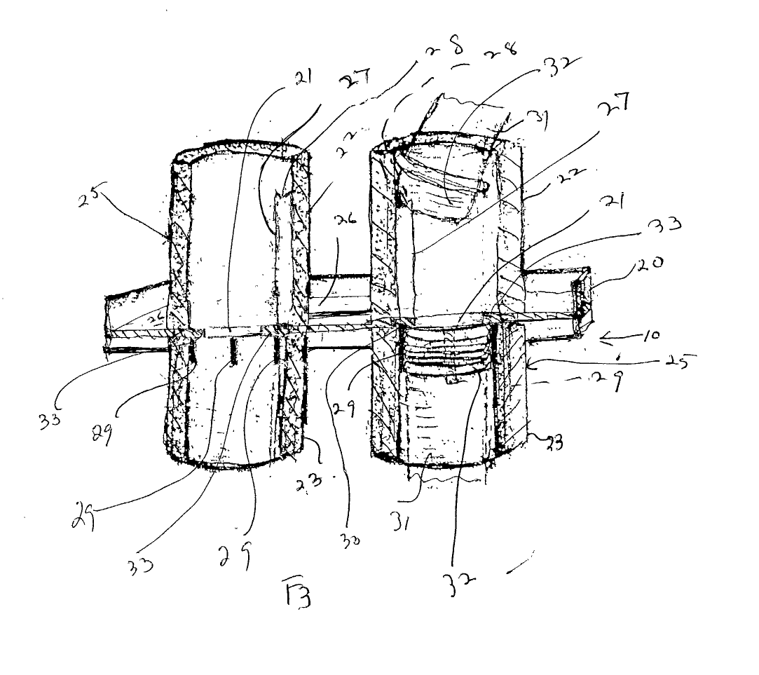

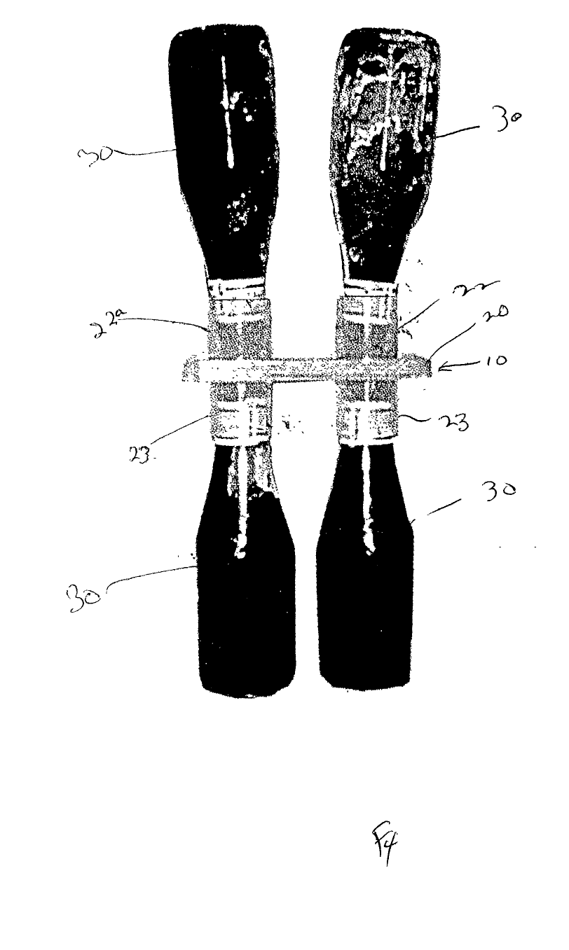

As shown in FIGS. 2 and 3 there are openings 21 between the bottle neck receivers 22 and bottleneck receivers 23. The bottle neck receivers 22 and bottle neck receivers 23 form individual couplings 25. Each bottle neck receiver 22 includes an internal neck support 27 which includes a notch 28. Each bottle neck receiver 23 includes a plurality of spacers 29. There are support ridges 24 on the base 26 between the bottle neck receivers 22. There are preferably, also support ridges 24 on the underside of the base 26 (not shown).

FIG. 3 is a vertical section of the coupler 10 showing the engagement of necks 31 of a bottles 30 in a bottle neck receivers 22 and 23.

FIG. 4 shows the coupler 10 in use with bottles 30 engaged in the coupler 10.

As shown in FIGS. 1-4 each coupling 25 comprises an aligned bottle neck receiver 22 and bottle neck receiver 23 over an aperture 21 separated by a base 26. The sets of couplings 25 receive the necks 31 of bottles 30 so that residual fluids such as ketchup can be consolidated in another partially used bottle 30.

As shown in detail in FIGS. 2 and 3, the bottle neck receivers 22 and 23 extend vertically from the base 26 over the apertures 21. Each bottle neck receiver 22 includes a neck support 27. The respective neck supports 27 appose each other. Each neck support 27 includes a notch 28. The bottle neck receivers 23 each include a series of spacers 29 on the inside periphery of the bottle neck receiver 23.

As shown in detail in FIG. 3 the necks 31 of two bottles 30 are engaged in a bottle neck receiver 22 and a bottle neck receiver 23 of the coupling 25. FIG. 4 shows the coupler 10, balance, in use with four bottles 30 engaged.

As shown in FIG. 1, the bottle neck receivers 22 and bottle neck receivers 23 extend from the base 26 over the apertures 21 forming two extending couplings 25.

As shown in FIG. 2, the drainage coupler 10 with the bottleneck receivers 22 and apertures 21 form one part of the coupling 25. The bottle neck receivers 22 and 23 each have an inner diameter greater than the aperture 21, thus rims 33 are formed in the couplings 25.

FIG. 3, shows a detail of the necks 31, cut away, of two bottles 30 engaged in a coupling 25. The bottles 30 shown in FIGS. 3 and 4 have a long narrow necks 31 with threads 32. The threads 32 are adapted to receive a bottle cover (not shown). The narrow neck 31 is typical of ketchup bottles for which the present invention is primarily directed.

As shown in FIG. 3, the neck 31 of one bottle 30 is engaged with the notch 28. That bottle 30 sits at a slight slant. The slant is a preferred position for drainage and to avoid the crowding of bottles 30. The neck 31 of another, cut away, bottle 30 is engaged in the bottle neck receiver 23. The neck 31 abuts the aperture 21 firmly held by the spacers 29. The engagement enables complete drainage of the ketchup from the upper bottle 30 to the lower bottle 30. The system works identically for more than one set of bottles 30 engaged, as shown in FIG. 4.

The drainage coupler 10 must be supported with a minimum of two bottles 30 in the bottle neck receivers 23. Thus as shown in FIG. 4 two bottles 30 support the coupler 10 and one or two bottles 30 may be drained simultaneously. The coupler 10 can fully function with only one bottle 30 engaged in a bottle neck receiver 22.

The system of the present invention does not require supervision once the minimum bottle combination is in place.

The terms and expressions which are employed are used as terms of description; it is recognized, though, that various modifications are possible.

It is also understood the following claims are intended to cover all of the generic and specific features of the invention herein described; and all statements of the scope of the invention which as a matter of language, might fall therebetween.

Having described certain forms of the invention in some detail, what is claimed is:

1. A bottle drainage coupler including a base, said base having an upper part and a lower part, at least two spaced bottle neck coupler sets extending from said base, said base including apertures sets therethrough, each said coupler set including a first bottle neck receiver on an upper portion of said base and a second bottle neck receiver apposed on a lower part of said base, each said bottle neck receivers selected to be large enough to receive the neck of selected bottles to be drained in said bottle drainage coupler, said bottle neck receivers at said apertures in said base and of size selected to receive the neck of a selected bottle spaced away from another selected bottle engaged bottle in said drainage coupler, each said bottle neck receivers in said upper part of said base in a set including an apposed internal bottle neck support spaced away from said aperture, and said bottle neck receivers in said IS lower parts of said base in said set each including means to firmly engage the neck of said selected bottles.

2. The invention of claim 1 wherein said bottle neck receivers form an inner rim at said apertures.

3. The invention of claim 1 wherein said first bottle receiver includes a neck support.

4. The invention of claim 3 wherein neck support includes a notch.

5. The invention of claim 1 wherein the said bottle neck receivers in said lower portion include spacers.

6. The invention of claim 1 wherein said base includes support means.

7. The invention of claim 6 wherein said support means includes at least one ridge.
